(19) United States
(12) Patent Application Publication
(10) Pub. No.: US 2005/0049040 A1
(43) Pub. Date: Mar. 3, 2005

(54) Remote monitoring

(76) Inventor: Christopher John Roberts, Kew (AU)

Correspondence Address: HOVEY WILLIAMS LLP, Suite 400, 2405 Grand Boulevard, Kansas City, MO, 64108, US

(21) Appl. No.: 10/872,152

(22) Filed: Jun. 17, 2004

Related U.S. Application Data
(63) Continuation of application No. PCT/AU02/01718, filed on Dec. 18, 2002.

(30) Foreign Application Priority Data
Dec. 18, 2001 (AU) PR 9586

(51) Int. Cl. A63F 13/00

(52) U.S. Cl. 463/25; 463/29

(57) ABSTRACT

A central control (2) monitors a plurality of electronic gaming machines (3) located at various venues (A,B). The EGMs (3) have meters (8-10) that record turnover, number of plays, and winnings. These values are sent to a site controller (4) where the turnover figures are summed in an accumulator (11) to provide a single summed value (ΣBETS) that is sent to the central control (2). These summed values (ΣBETS) are used to monitor the machines (3) e.g. by determining a delta value (13) as a difference between a presently received summed value and a previously received summed value. The central control (2) may monitor usage, conduct an audit or a regulatory role, and/or may provide a linked jackpot between various venues.

This application is a continuation of International Application No. PCT/AU02/01718 filed 18 Dec. 2002 and published in English, and claiming priority from Australian application no. PR 9586 filed 18 Dec. 2001.

The present invention relates to systems and methods the remote monitoring of a number of devices over a network. It relates particularly, though not exclusively, to the remote monitoring of electronic gaming machines.

Typically, a gaming establishment will have a number of electronic gaming machines installed on site that need to be remotely monitored by a central control.

This monitoring could be required for a number of purposes, for example to determine real-time usage of the gaming machines, to audit the machines, and/or to enforce regulatory regimes imposed on their use.

In order to provide this monitoring, the central control needs to obtain information from the various gaming machines as to their status. This information generally comprises three values that are constantly metered by the machines. These values correspond to the amount bet on the machine (turnover), the number of plays of the machine, and the winnings paid out.

Thus, the central control receives frequent downloads of the three metered values from each gaming machine.

Such systems can, however, be problematic in various respects, and may be expensive to run and potentially slow to react to changes in state of the electronic gaming machines.

The present invention provides new monitoring systems and methods aimed at addressing such problems.

Viewed from one aspect, the present invention provides a gaming machine system for remotely monitoring gaming machines, the gaming machines each including at least one meter that provides metered data, wherein the system includes a plurality of local accumulators, each accumulator being in communication with one or more of the gaming machines for receiving metered data from the machines, and each accumulator summing together metered data from its associated machines and communicating the summed data to a remote central control.

Generally, although not necessarily, the accumulator will connect to the remote central control through a Wide Area Network (WAN) connection, and the present invention enables the usage of this connection to be reduced. Thus, instead of data from each of the individual gaming machines being sent to the central control, data traffic may be reduced to a single periodic communication for all of the machines connected to an accumulator.

Thus, the present system is able to reduce the bandwidth requirements in the connection between a gaming venue and the central control, so that bandwidth is dictated more by the number of accumulators in the system than by the usually much larger number of individual gaming machines. This can result in significant cost savings, which can be appreciated still further, when it is realised that each prior art transfer of individual machine data would need not only a communication to send that data but also surrounding integrity checking and acknowledgement communications and the like.

Generally, there will be an accumulator at each gaming venue, and bandwidth savings and simplified communications control can be provided for each of the connections between the central control and each of these various venues.

The resulting decrease in traffic can also facilitate increases in the response times of the system, since communications are more likely to be transmitted successfully and dealt with more speedily.

The metered values are values internally recorded by an electronic gaming machine, which continually update as and when an event occurs such as a bet or a play or a win. They are generally not reset, and continue to increase over the life of the machine, unless the meter rolls over to count again from zero, or the meter is purposely reset, e.g. on being taken to a new venue.

Any of the metered values may be summed by the accumulator and forwarded to the central control, depending on the type of monitoring/control required. Preferably, the metered data that is summed comprises data from the turnover meters of the electronic gaming machines. Thus, the other metered values relating to the number of plays and the amount of winnings are not usually repeatedly forwarded to the central control. Instead, if required, these figures are sent at less regular intervals or on an event-driven basis, e.g. to record a gaming machine's status on a security alert, such as the opening of an access door, or on receiving a specific request for the information from the central control.

Since the metered data is generally continually updated by the relevant gaming machine, there is often no need to continually meter these values, as whenever the central control does receive these figures, they will be up-to-date.

In one embodiment, all three metered values may be sent up to the central control when an electronic gaming machine initially logs onto a system at the start of a session and/or when its logs off a system at the end of a session.

A point to note is that the summed value that is passed to the central control by the accumulator will generally comprise the sum of all of the active gaming machines, irrespective of whether any one particular machine has had any turnover or not since the last transmission of the summed data.

Another point to note is that no indication need be made in the communications from the accumulator to the central control of the individual gaming machine contributions to the summed amount, as the central control will generally be more interested in the overall turnover of a venue rather than the turnover of individual machines.

The central control may use and store the received values, and for example time-stamp them, as desired, and could merely store the data for future use.

In a preferred embodiment of the present invention, the central control determines a difference between a presently received summed value and a previously received summed value to obtain a delta value that corresponds to the turnover of a venue's machines over the time period that has elapsed between the receipt of, or more accurately the calculation of, the two summed values. This delta value can then be used in monitoring the usage of a venue's machines over time, and/or to operate a linked jackpot between a number of machines at a number of venues. In a similar manner, instead of the central control determining the delta value, the accumulators could determine delta values for each individual gaming machine, and could transmit a summation of the delta values to the central control.

The accumulator itself may receive only the turnover data from each of the associated gaming machines. Preferably, however, the accumulator receives other metered values as well, such as win and play data, which it may record but not pass on to the central control. The accumulator then has these values available should, for example, a request be sent for them from the central control or should the accumulator need to use them. When sent, these other values may also be summed, or may be sent as individual machine values.

In one embodiment, the accumulator need not store any of the metered information received from the gaming machines, as once the information is up-loaded to the central control, the central control can record the information for later use. Preferably, however, the accumulator stores all or some of the received metered data either in a summed form or individually for each gaming machine associated with it. This information may be stored for as long as is desired, and this may be determined for example so as to hold a set number of the summations sent or so as to hold summations sent for a set time period.

If needed, therefore, this extra information can be up-loaded to the central control on request or can be used by the accumulator. For example, storing the individual contributions would allow the accumulator to identify the individual contributions made by each of the gaming machines to the summed value that was sent to the central control. If required, the central control could then request this information from the accumulator should this be needed for a more detailed analysis of a certain time period.

The accumulator may receive the metered data from the individual machines at any suitable times. Preferably, the data is sent to the accumulator at set time periods and/or on an event-driven basis.

Preferably, the data is sent to the accumulator at time intervals that are less than the time needed to play a game, so that the accumulator can accurately track plays and can respond to them in good time. Typically, the time intervals between receiving data from a machine may be about 2.5 seconds or less. An allowance may also be made for the time needed to pass the data from the accumulator to the central control, and for the central control to process the data and make any required reply.

The present invention preferably takes extra steps when a gaming machine first connects with an accumulator during a session, and becomes active. The need for this can be seen when considering the calculation of the delta value, i.e. the increment of the turnover since a previously summed value, when a new machine has come on-line. Thus, if a new machine were to come on-line, then the next summed value sent from the accumulator to the central control would include the new machine's total metered value, and so the delta value calculated using this summed value (and using the previously received summed value) would include this total metered value rather than just a turnover of the new machine since the last summed value was sent.

In order to solve this problem, when the accumulator detects a new machine, it preferably conducts a summation of the relevant metered values for all of the active machines, including the new machine, and sends this to the central control along with the relevant metered value or values of the new machine. This preferably occurs in a single communication, and preferably also the accumulator takes the opportunity to send up other metered data from the new machine as well, so that for example the central control can keep a record of the start-up conditions of gaming machines as they connect to a session.

When the central control receives this information, it can first calculate the delta value in the normal manner by subtracting the previously received summation value from the present summation value. It will also realize that a new machine has come on-line (e.g. due to the additional data in the communication or due to the setting of a flag by the accumulator in the communication), and will subtract the new machine's metered value from the initial delta value to provide a correct delta value.

This operation need only occur for this first calculation, as all subsequent summed values received from the accumulator will have the new machine's original turnover figures included in it, and so these will cancel out on each new delta function calculation.

A similar procedure is preferably carried out when a machine becomes inactive, e.g. goes off-line. In this case, however, the next summed value sent up to the central control after a machine goes off-line will not include the metered data for that machine.

In order to correct this, the accumulator may send the last recorded metered data of the now off-line machine to the central control, e.g. in the same communication as the summed value is sent. The central control may then add the machine value to the initially calculated delta value to give a correct delta value.

Again, the opportunity may be taken to up-load other metered data from the off-line machine so that the central control can determine the status of the machine on finishing its session.

In this regard, the accumulator may only realize that a machine is to go off-line after this has actually happened, and so, in order to send the final status information relating to the machine, it will need to store at least the last received data set record for each of its machines.

In some cases, a gaming machine's meter may roll-over to zero because it has reached the meter's count limit. The accumulator may be configured to recognize this fact, and to advise the central control accordingly in one preferred embodiment, the accumulator flags that a machine has rolled-over, and the central control will add the maximum value of the meter to the next delta value that is calculated from the summed value received from the accumulator. This then corrects the present delta value, and later delta values will not be affected. The central control may already know the maximum meter values at which roll-overs can occur, or the accumulator may advise of this on flagging the roll-over.

Preferably, a group identification, such as a number, is added to each communication from an accumulator to the central control to identify a collection of gaming machines to which the metered data relates. This then allows a venue to arrange their machines into more than one logical group, for example so that the machines may participate in different linked jackpots or in no jackpot at all.

The accumulator may send the summed metered data for each group to the central control separately, or the different summed values may be sent together in a single communication, each value being associated with a relevant group identification.

Preferably, also, the communication with the central control includes a venue identification so that the central control can track from which venues the data is being sent.

Preferably, the accumulator adds a sequence identification to each summed data communication sent to the central control. This sequence identification could take any form, and may for example comprise a number, e.g. obtained by cycling through a series of numbers such as 1-256.

The accumulator preferably also stores the data received from the machines under the same sequence numbers. This information may be the summed values and/or the individual data received from the gaming machines, as appropriate.

The use of sequence identification can be useful when an interruption in communications occurs, and can help to take into account latency in a network caused by the time needed for information to travel to the central control and be processed.

For example, if the connection between an accumulator and the central control is lost, then, on re-connecting, the central control can advise the accumulator of the last received sequence number, and the accumulator can re-transmit any sequence numbers that it had send but were not received, i.e. up to the sequence number currently being used by the accumulator.

Also, should an event occur in relation to a specific sequence, e.g. a large increase in turnover, the central control may wish to investigate the individual gaming machine data. In order to obtain this data, the central control may need to specify to the accumulator the sequence number of the data required. This is because the accumulator may have sent a number of further sequences during the time taken for the central control to receive, process and request information on the sequence of interest.

The central control may also wish to determine detailed data e.g. for a particular time each day, e.g. in order to keep a daily record of turnover. By using sequence numbers, the central control can request the detailed data of the sequence number received at e.g. 2100 hours every day or every hour or the like.

The invention has found particular advantage when employed to control linked jackpots, in which machines from a number of venues pool a portion of their turnover to a common jackpot that is then won by one of the participating machines, e.g. on the occurrence of a set trigger which may take a number of different forms.

In a linked jackpot, the present invention allows the central control to calculate the delta values for the participating machines from each venue, and the central control can then calculate a percentage of the delta value which is to be put to the jackpot so as to determine a current jackpot value.

The central control can check for the triggering of the jackpot and inform the relevant accumulator (i.e. the accumulator monitoring/controlling the winning gaming machine) accordingly.

Triggering may be time-dependent or event-dependent, e.g. the prize may be allocated at a specific time during play or after a set time period and/or when a particular event occurs at a gaming machine, such as a particular type of win.

In one preferred embodiment, the awarding of the jackpot is triggered when the jackpot value reaches a threshold value. This value may be set by the central control, and may be calculated as a random value, e.g. between minimum and maximum limits.

In this embodiment, the central control may alert the accumulator whose delta value caused the jackpot value to reach the threshold value. The accumulator may then assign the prize to an appropriate gaming machine under its control.

In order to do this, the accumulator may determine the individual contributions made by each of its participating machines to the delta value, e.g. by subtracting, for each of the individual participating machines, that machine's previous turnover figure from the figure used to provide the winning delta function.

In order to determine which figures to use, the central control preferably sends the accumulator the sequence number associated with the winning delta value, and the accumulator determines the individual contributions of the individual machines from the data for that sequence number and from the data for the previous sequence number.

In order to determine which machine should receive the winning, the accumulator may randomly select the machine. The selection may be weighted depending on the size of the contribution that each machine has made to the winning delta value.

Alternatively, the central control may calculate the amount of the winning delta value that caused the win, e.g. only 50% of the actual delta value may have been needed to take the jackpot value over the win threshold. The central control may then send this figure to the winning accumulator, which may then determine the winning machine by adding up the contributions made by the individual machines, until this percentage value is reached or surpassed. The accumulator may then award the prize to the machine whose added contribution reached or surpassed the percentage value (or for example to the next machine in the list).

Preferably, the contributions are added in the same machine order for every win.

It should be noted that the time periods over which the accumulator receives data from the machines and sends data to the central control is controlled so that the process of determining a jackpot winning machine can occur within an appropriate time limit such that a player does not walk away from a machine before notification of the win is given. Thus, the accumulator may receive the machine metered data within the time needed for a play to end.

It should be noted that the reduction in traffic provided by the present invention and the summation of the individual machine data by the accumulators can facilitate speedy response of the system to a jackpot win.

The jackpot application of the present invention is particularly important in itself, and, viewed from a further aspect, the present invention provides a linked jackpot system, in which a plurality of gaming machines at a plurality of venues are linked together by a remote central control to play for a common jackpot prize, wherein each venue includes an accumulator for receiving metered data from the participating machines at that venue and for summing said data and sending said data to said central control, said central control processing said summed data to control said common jackpot.

Preferably, the summed data is turnover data, and preferably the processing is the calculation of a delta value (difference value) between a currently received summed value and a previously received summed value.

Further preferably, the summed data is assigned identification data, the identification data being sent to said central control along with said summed data. The central control preferably informs the relevant accumulator of the summed value that provided the winning jackpot, using the identification data, so that the accumulator can use the stored data associated with the identification data to determine which gaming machine is to win the jackpot, e.g. by determining the individual contributions to the summed value that triggered the jackpot.

The accumulator for any of the above systems may be provided on a site manager of the gaming venue, e.g. a local central control for the gaming machines of that venue, and may be provided as dedicated hardware, or as firmware or as software. The accumulator/site manager may comprise a separate device from the gaming machines, e.g. a personal computer or the like, or may be provided in one of the gaming machines.

The accumulator may communicate with the gaming machines in any suitable manner, e.g. through a Local Area Network (LAN), which may be for example an Ethernet, Token Ring or FDDI LAN, and each gaming machine may have an appropriate network card to connect to the network.

The accumulator may communicate with the central control in any suitable manner, e.g. through a WAN, e.g. using public networks, leased lines and/or the Internet.

It should be further noted that the present invention can have application outside of the field of electronic gaming machines, and could for example be used in any field in which there was a need to monitor metered data from a plurality of groups of devices.

The invention therefore extends to a remote monitoring system in which a plurality of metered devices are monitored by a remote central control, wherein the metered devices are split into groups, e.g. by virtue of location, and each group of devices has an accumulator associated therewith for receiving metered data from the individual devices of the group and for sending a sum of the metered data to the central control for processing.

Examples of such systems could include the monitoring of people through the turnstiles of a venue or the monitoring of cash registers in a supermarket or the like. In the latter case, for example, the metered variables might be the amount of turnover of a register, the amount of cash in the register, and the amount of the turnover paid by credit card.

The present invention extends to the use of any of the above-mentioned features in combination, and to methods of controlling or monitoring a plurality of metered devices in accordance with any of the above features, as well as to accumulators and central controls for implementing the systems.

Thus, viewed from a further aspect, the present invention provides a gaming machine monitoring method for monitoring a plurality of gaming machines from a remote site, the method including the steps of: providing a plurality of local accumulators, each accumulator associated with a plurality of the gaming machines; summing metered data from the associated machines of the local accumulators; and passing the summed data from the local accumulators to a remote central control.

The present invention further provides gaming machine software for a local controller that monitors a plurality of local gaming machines, including a component for receiving metered data from the machines, a component for summing the received data, and a component for transmitting the received data to a remote monitoring station.

The present invention also provides gaming machine software for a central control for monitoring a plurality of remote gaming machines, the software including a component for receiving summed metered data from a remote controller associated locally with the gaming machines, a component for storing the summed data, and a component for determining a summed delta value comprising the difference between a current summed value for the metered readings of the machines of the remote controller and a previously transmitted value.

The present invention still further provides a gaming machine accumulator that monitors a plurality of local gaming machines, the accumulator receiving metered data from the machines, summing the received data, and transmitting the received data to a remote monitoring station.

The present invention also provides a gaming machine central control for the monitoring of remote gaming machines, the central control including means for receiving summed metered data from a remote controller associated locally with the gaming machines, means for storing the summed data, and means for determining a difference between a current summed value for the metered readings of the machines and a previously transmitted value.

The present invention further provides a system for the remote monitoring of a plurality of gaming machines having metered data, wherein the gaming machines communicate with a local accumulator that sums together metered data from the machines, and wherein the accumulator forwards this summed data to a remote central control.

An embodiment of the present invention will now be described, by way of example only, with reference to the accompanying drawings. It is to be understood that the particularity of the drawings does not supersede the generality of the preceding description of the invention. In the drawings:

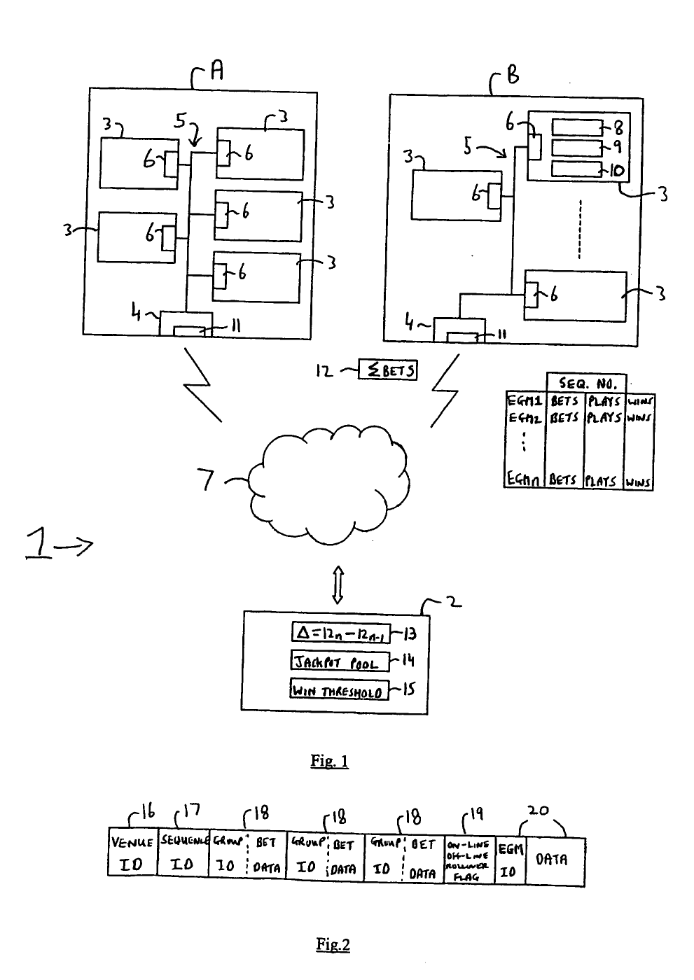

FIG. 1 is a schematic diagram of a remote monitoring system in accordance with an embodiment of the present invention; and

FIG. 2 is a schematic diagram of a data communications package sent from an accumulator to a central control.

Referring to FIG. 1, a monitoring system 1 is shown, in which a central control 2 oversees the operations of a plurality of electronic gaming machines (EGMS) 3, which may be located at a number of venues, e.g. A, B.

Each venue A,B has a site controller 4 for local control of the venue's EGMs 3. The site controller 4 and EGMs 3 are connected together through a local area network (LAN) 5, such as an Ethernet LAN.

In order to connect to the LAN 5, each EGM 3 includes a network interface card 6 (also known as a Gaming Machine Interface Card or GMIC).

The site controller 4 may for example be a personal computer running appropriate software, but could also be a dedicated device or one of the EGMs 3 nominated to provide this function.

The site controller 4 communicates with the central control 2 over a wide area network (WAN) 7, which may take any suitable form as are well known in the art, and may comprise telephone and/or Internet connections.

The central control 2 monitors and controls the EGMs 3 through the site controllers 4.

The central control 2 may for example monitor EGM usage at the various venues and may conduct audits. It may also run linked jackpots and the like.

In a linked jackpot, a number of the EGMs 3 at each venue A,B may contribute a percentage of the bets placed on them to a central jackpot that may then be won by any of the participating machines in accordance with various conditions, e.g. when a set jackpot payout is reached, or when a set event occurs, or at a set time.

In order to monitor/control the EGMs 3, the central control 2 needs information as to their status. Each EGM 3 includes three meters 8-10 (generally “soft meters”, in that they are embodied in software in the GMICs 6). These meters 8-10 record respectively the bets placed on a machine (turnover), the number of plays of the machine, and the winnings paid out by the machine. They are generally incremented by one for each unit of a bet made or for each play made or for each unit of a winning paid out.

In accordance with the present invention, the site controller 4 includes an accumulator 11, e.g. as a software component. This accumulator 11 receives the metered data from the EGMs 3, and then sums the turnover metered data 8 from all of the machines 3 to provide a single summed value 12 that is then sent out to the central control 2.

The central control 2 uses such summed values 12 in monitoring the EGMs associated with that accumulator 11. For example, the central control 2 may determine the difference between a current summed value 12ₙ and the summed value 12ₙ₋₁ received in a previous communication, in order to determine a delta value 13 that corresponds to the usage of the machines at the relevant venue over the period between the output of these two summed values.

The central control 2 may also sum this delta value 13 with previous such delta values in order to keep a running total of the usage of the EGMs 3 over time during any particular usage session.

It should be noted that the accumulator 11 need not receive all of the types of metered data 8-10, and could just receive the turnover data 8. Preferably, however, it does receive all three types of metered data, as the information will then be on hand should the central control 2 decide that it needs this data e.g. for auditing purposes or to check the individual data for the last summed value 12 that was sent.

The central control 2 may run a linked jackpot between a number of the EGMs 3 at a number of venues, such as A and B.

In the linked jackpot, as said, each of the participating EGMs 3 allocates a percentage of each amount bet to a common jackpot pool 14 controlled by the central control 2. This pooled amount 14 thus increments with every bet of the various EGMS 3, until it is determined that one of the EGMs 3 has won the jackpot prize.

Various different conditions may exist to trigger the winning of the jackpot 14. In one preferred embodiment, the central control 2 determines a win threshold 15.

This threshold 15 may be set at a random amount between set maximum and minimum limits, e.g. using a random number generator. When the jackpot 14 reaches this threshold 15, a prize of the threshold amount is awarded.

Whilst awaiting the award of the prize, the current jackpot value 14 is repeatedly sent from the central control 2 to all of the accumulators 11 that have participating EGMs 3, so that the jackpot value 14 can be displayed at these machines. The jackpot display may be provided at each individual machine and/or at one or more separate displays, e.g. provided above a bank of machines linked to the jackpot.

In accordance with the present invention, when running a linked jackpot, the difference is found between a current turnover summation 12ₙ received from an accumulator 11 that is participating in the jackpot and the previous summation value 12ₙ₋₁ from that accumulator. This determines a delta amount 13 of turnover for that venue's jackpot machines since the last calculation.

A percentage of the resulting delta amount 13 is added to the jackpot total 14, and a check is made as to whether this total has exceeded the prize threshold 15.

If the threshold 15 has not been passed, then the central control 2 continues to process the summed values 12 from the accumulators 11 and to add appropriate percentages to the jackpot 14.

If the current jackpot value 14 reaches or exceeds the prize threshold 15, then the central control 2 communicates that a win has been achieved to the appropriate accumulator 11, i.e. the accumulator 11 whose summed value 12 has caused the threshold 15 to be reached. The accumulator 11 then determines which of its EGMs 3 should receive the prize, and instructs the chosen EGM 3 accordingly, so that the appropriate win is displayed.

The accumulator 11 may assign the win to one of its participating EGMs 3 in any suitable manner. In order to assist in this, it may keep a record of the individual EGM turnover data 8 which it summed and output to the central control 2 as the winning summed value 12.

It may do this by keeping a record of the individual turnover data for each of the EGMs 3 for the most recent summation values. It can then determine the individual turnover data associated with the winning summation value 12ₙ and with the preceding summation value 12ₙ₋₁ and can then calculate a delta value for the turnover 8 for each of the individual EGMs 3 to determine the contribution that each of the EGMs 3 made to the winning delta value 13.

Once it has this individual information, the accumulator 11 can choose the winning EGM. It does this, in one embodiment, by randomly selecting one of the EGMs 3, whilst weighting the probability of each machine winning in accordance with each machine's contribution to the winning delta value 13.

In an alternative embodiment, the central control 2 determines the amount of the delta value 13 that prompted the triggering of the jackpot, i.e. the difference between the threshold value 15 and the jackpot total 14 as in existence before the winning increment of the jackpot 14. This value is sent to the winning accumulator 11, which then uses the value to determine which of its EGMs 3 should receive the prize.

Thus, on reaching the jackpot threshold 15, the appropriate accumulator 11 will receive a signal from the central control 2 that its last summed value 12 triggered the jackpot prize and that the jackpot 14 was triggered by e.g. the first $50 of the corresponding delta value 13 (this may alternatively be expressed as a percentage of that value).

The relevant accumulator 11 will then use this $50 value to determine which of its EGMs 3 should win the prize, i.e. by determining which of the EGMs had played the fiftieth dollar of the last summation. To do this, it may add up the individual contributions of each of the machines 3 in a set order of the machines, and will award the prize to the machine 3 whose individual contribution caused the $50 value to be reached or passed.

An important feature of the present invention is that the data forwarded to the central control 2 is allocated identification data, e.g. a sequence number. This may for example be chosen from a number series, e.g. 1-256, which is repeatedly cycled through. Also, the individual data 8-10 that provides the summed data 12 is recorded in a file by the accumulator 11 under the same sequence number.

This allows the system to both deal with interruptions in communications and also to take account of latency in the network, i.e. the time needed to propagate and process data.

Thus, if a disruption in the communications occurs, then, on reconnection, the accumulator 11 and central control 2 can compare the sequence number of the last summed value 12 sent or received, and if they are not the same, the accumulator 11 can re-send the unreceived values 12, thus synchronizing the two devices.

Also, when controlling a linked jackpot, by the time that the central control 2 has received a summed value 12ₙ from an accumulator 11, has determined that the jackpot has been triggered by the summed value 12ₙ and has informed the relevant accumulator 11 of this, the accumulator 11 may well have issued a number of new summed values 12ₙ₊₁, 12ₙ₊₂, . . . 12ₙ₊ₓ, to the central control 2.

The sequence number therefore allows the accumulator 11 to determine which of the summed values 12ₙ provided the trigger, and so allows the accumulator 11 to correctly assign the jackpot.

The accumulator 11 may store as many sequence records as needed, depending, for example, on the determined network latency. For example, the last five sequence records may need to be retained to ensure that a sequence is not deleted before the central control 2 has had time to inform the accumulator 4 of the sequence's relevance. This value may be modified in real-time through real-time monitoring of the latency.

In a further feature, the accumulators 11 allow the EGMs 3 to be grouped together into a number of different groups. They do this by allocating the EGMs to particular groups, and by providing a group identification number to each group.

There may be a number of reasons for wanting to divide the EGMs 3 into separate groups. For example, the EGMs 3 of a venue may be playing in different jackpots run by the central control 2, or by other central controls, or may be in no jackpot.

Thus, when sending the summed value 12 to the central control 2, the accumulator 11 determines a separate sum for each group and passes this summed value to the central control 2 along with its group identity number. These individual group summations may be sent separately to the central control 2, or may be sent in one message.

As well as sending the summed turnover values 12, the accumulators 11 may also send data relating to the other metered values 9,10. This need not occur so often, and may for example comprise only one communication per session, either at the start or end of a session.

A point to note is that when an EGM is brought on-line at a venue, e.g. at the start of an evening, the first turnover value 8 which it contributes to the summed turnover 12 will be its turnover to date and not since the current session started.

If no account is taken of this, then problems could arise, in that when a machine 3 is started-up, the summed turnover 12 from the accumulator 11 would jump by the initially held turnover 8 of that machine 3 rather than by its contribution in the current usage session and so would give an incorrect delta value 13 by this amount at the central control 2.

Accordingly, when a machine 3 is brought on-line, the accumulator 1 detects this, and, at that time, sends both a sum of all of the turnover values for the individual machines 3 (including the newly activated machine), and also the individual turnover data 8 of the new machine 3 to the central control 2, with an indication that the summed data includes a contribution from a new machine. Preferably, this is achieved in a single message.

The accumulator 11 may also take the opportunity to send up in this communication, values for all three types of metered data for the new machine.

The central control 2 will then record this individual turnover data 8-10, and will not only conduct the usual delta function with the last summed value 12, but will also correct this value by subtracting from it the new machine's initial individual turnover data.

The next summation 12 and delta value 13, after the corrected delta value 13, will not need correcting, since both summed values 12 used in the subsequent delta value calculations will include the new machine's turnover figures.

A similar process should be undertaken when a machine goes offline, as the delta function after that machine's initial removal will also be wrong, i.e. will be reduced by the leaving machine's total individual turnover value. In this case, the central control 2 adds the individual turnover value of the leaving machine to the delta value initially calculated.

As above, the central control 2 may receive this initial value from the accumulator 11 in the same communication as the summed value 12.

The leaving turnover value of the off-line machine will need to be obtained from the individual data used for the previously sent summed value 12, as it will not be available for the present summed value (the machine having gone off-line).

Another situation in which correction of the delta value 13 may be required is when a machine's meter rolls over, i.e. reaches its maximum count and resets to zero. To take account of this, the accumulator 11 should detect a roll-over, e.g. by comparing a present count to that of a previous count, and should indicate this to the central control 2, e.g. with a flag. The central control 2 may then correct the delta value 13 on that occasion by increasing the delta value by the maximum meter count, e.g. as received from the accumulator 11 or as already known to it.

The timing of the collection of individual machine data 8-10 by the accumulator 11 and the sending of a summed value 12 to the central control 2 should be such that control of the EGMs 3 and display of winning jackpots and the like can occur sufficiently quickly that a user will not walk away from their machine 3 before notification.

For example, the accumulator 11 may receive the individual data 8-10 and send the summed data 12 at intervals which are less than the duration of an individual play, this may be e.g. once every 2.5 seconds or less.

Overall, a message to the central control may take the form as shown in FIG. 2.

As can be seen, the message comprises a venue ID field 16, e.g. either A or B in the present case, a sequence number field 17, and a number of data pair fields 18, each pair consisting of a group ID and a corresponding turnover summation figure that corresponds to the summation of all of the metered turnover values of the EGMs 3 of the identified group.

The message may also include a flag field 19 to indicate that a machine has newly come on-line or gone off-line or has rolled-over, and associated fields comprising the particular EGMs identity (e.g. its GMIC number), and the individual data for that machine, e.g. just the individual turnover data or all three types of data or the maximum meter number before roll-over, if needed.

Of course, the message of FIG. 2 will in practice also have other fields, such as header and footer information relating to the transfer protocol and the like used in the WAN, and may need more than one flag and associated data fields if two or more machines come on-line or the like at the same time.

It is to be understood that various alterations, additions and/or modifications may be made to the parts previously described without departing from the ambit of the present invention, and that, in the light of the teachings of the present invention, the various monitoring network components and functions may be implemented in software, firmware and/or hardware in a variety of manners.

For example, the accumulator could send out one of the other metered values as the summed value and/or could send out two or more summed values to the central control each time.

Also, the invention is not limited to the monitoring of EGMs, but could be used in any situation in which a device includes one or more metered values, and in which it is desired to measure the amount of this change from a remote location. Examples of this could include the monitoring of people through the turnstiles of a venue or the monitoring of the cash registers in a supermarket or the like. In the latter case for example the metered variables might be the amount of turnover of a register, the amount of cash in the register, and the amount of the turnover paid by credit card.

Although the delta function is carried out at the central control in the disclosed embodiment, it could instead be carried out at the accumulator (so that a value is passed to the central control relating to the summed values of the individual EGM delta values).

1. A gaming machine system for remotely monitoring gaming machines, the gaming machines each including at least one meter that provides metered data, wherein the system includes a plurality of local accumulators, each accumulator being in communication with one or more of the gaming machines for receiving metered data from the machines, and each accumulator summing together metered data from its associated machines and communicating the summed data to a remote central control.

2. The system of claim 1, wherein the metered data that is summed includes turnover data.

3. The system of claim 1, wherein the summed data communicated by an accumulator to the remote central control is a summed delta value, being the sum of a delta value for each of its associated machines, the delta value being a difference between a present value of a machine's metered data and a previous value of that machine's metered data.

4. The system of claim 1, wherein the summed data communicated by an accumulator is the sum of the values of the metered data from the gaming machines, and wherein the central control determines a summed delta value for the machines of the accumulator, the summed delta value being a difference between a present value of the summed metered data and a previous value of the summed metered data.

5. The system of claim 3 or 4, wherein the central control processes the summed delta value and determines an action based on the processing of the summed delta value.

6. The system of claim 5, wherein the central control requests individual gaming machine data from an accumulator based on the processing of a summed delta value associated with that accumulator.

7. The system of claim 1, wherein, when an accumulator detects a change of state in a machine associated with it, a compensation value is determined to compensate the summed data for the change in state.

8. The system of claim 1, wherein, when a machine comes on-line, summed data corresponding to when the machine came on-line is compensated by subtracting from the summed data the machine's metered data when it came on-line.

9. The system of claim 1, wherein, when a machine goes off-line, summed data corresponding to when the machine went off-line is compensated by adding to the summed data the machine's metered data when it went off-line.

10. The system of claim 1, wherein, when a machine's meter rolls over, summed data corresponding to when rollover occurred is compensated by subtracting the meter's rollover value from the summed data.

11. The system of claim 7, wherein compensation is carried out by the central control.

12. The system of claim 1, wherein when an accumulator detects a new machine, the accumulator conducts a summation of the metered data for all of the active machines associated with it, including the new machine, and communicates the summed data to the central control along with individual metered data of the new machine.

13. The system of claim 12, wherein the central control calculates a delta value by subtracting previously received summed data from presently received summed data, and subtracts a new machine's metered data from the delta value to provide a corrected delta value.

14. The system of claim 1, wherein when the accumulator detects that a machine has become inactive, the accumulator sends the last recorded metered data of the inactive machine to the central control, and the central control adds the machine's last recorded data to a calculated delta value to give a corrected delta value.

15. The system of claim 1, wherein when an accumulator detects that a meter of an associated gaming machine has rolled-over, the accumulator informs the central control, and the central control adds the roll-over value of the meter to the summed data to correct the same.

16. The system of claim 1, wherein the accumulator stores at least the last received data for each gaming machine associated with it, in order to determine final status information relating to a machine when it detects that a machine has gone offline.

17. The system of claim 1, wherein when a gaming machine logs onto and/or logs off of the system, the associated accumulator communicates metered values corresponding to turnover, number of plays and winnings to the central control.

18. The system of claim 1, wherein each accumulator stores the individual data contributions from its associated machines to allow the accumulator to identify the individual contributions made by each of its associated machines to the summed data that the accumulator communicates to the central control.

19. The system of claim 1, wherein the accumulators store individual metered data on each of their associated machines, and wherein individual metered data is forwarded to the central control on request.

20. The system of claim 1, wherein the accumulators communicate turnover data and other metered data, e.g. the number of plays made and/or the winnings paid out, to the central control, and wherein said other metered data is communicated less often to the central control than the turnover data.

21. The system of claim 20, wherein said other metered data is communicated on an event-driven basis.

22. The system of claim 1, wherein each accumulator is associated with a venue, and wherein each accumulator transmits a venue identifier with the summed data.

23. The system of claim 1, wherein the gaming machines of an accumulator are divided into two or more groups, and wherein the accumulator transmits a summed metered value for the machines of each group.

24. The system of claim 1, wherein each accumulator transmits a sequence identifier with the summed data to identify the data's position within a data sequence sent from the accumulator to the central control.

25. The system of claim 24, wherein if the connection between an accumulator and the central control is lost, on re-connecting, the central control advises the accumulator of a last received sequence identifier, and the accumulator determines from the last received sequence identifier whether any data was not received, and retransmits that data.

26. The system of claim 24 or 25, wherein the central control communicates a sequence identifier associated with a summed data communication, to an accumulator, in order to obtain information on that data.

27. The system of claim 1, wherein data is sent to an accumulator from a gaming machine at set time periods and/or on an event driven basis.

28. The system of claim 1, wherein data is sent to an accumulator from a gaming machine at time intervals that are less than the time needed to play a game on that machine.

29. The system of claim 1, wherein data is sent to an accumulator by a machine at time intervals of about 2.5 seconds or less.

30. The system of claim 1, wherein the system controls a linked jackpot formed between two or more sets of gaming machines, each set of machines including at least one accumulator.

31. The system of claim 30, wherein the jackpot is triggered in a time dependent or event-dependent manner.

32. The system of claim 30, wherein the jackpot is triggered when the value of the jackpot reaches a threshold value.

33. The system of claim 30, wherein the accumulators send summed turnover data to the central control, and wherein the central control determines a difference between a presently communicated turnover data value with a previous value to provide a delta value, and wherein the central control allocates a portion of the delta value to increase a jackpot value.

34. The system of claim 30, wherein the accumulators send summed turnover data to the central control, the summed turnover data being a sum of delta values of the individual machines, a delta value being the difference between a machine's current turnover value and a previous value, and wherein the central control allocates a portion of the summed value to increase a jackpot value.

35. The system of claim 30, wherein when a jackpot is triggered, the central control allocates the jackpot to an accumulator.

36. The system of claim 35, wherein an accumulator that is allocated a jackpot win, assigns a prize to a gaming machine under its control.

37. The system of claim 36, wherein an accumulator that is allocated a win determines the individual contributions made by each of its participating machines to the summed data value that was associated with the win, and determines which machine is to win a prize based on the individual contributions.

38. The system of claim 35, wherein the central control sends a winning accumulator a data sequence identifier associated with a winning summed data communication, and the accumulator determines the individual contributions of the machines for the data of that sequence identifier.

39. The system of claim 35, wherein an accumulator that is allocated a jackpot win randomly selects a winning machine from its associated machines.

40. The system of claim 35, wherein an accumulator that is allocated a jackpot win selects a winning machine in a manner weighted depending on the size of the contribution that each machine made to the summed data value associated with the win.

41. The system of claim 35, wherein the central control calculates the portion of a summed value that caused a win and communicates this value to a winning accumulator, and the winning accumulator determines a winning gaming machine by adding up contributions made by its individual machines until the portion value is reached.

42. The system of claim 41, wherein contributions are added in the same machine order for every win.

43. The system of claim 30, wherein the time periods over which each accumulator receives data from each of its associated machines and sends data to the central control is controlled such that the process of determining a jackpot winning machine can occur within an appropriate time limit such that a player does not walk away from a machine before notification of a win is given.

44. The system of claim 30, wherein the period of time between which an accumulator receives metered data from a gaming machine is within the time needed for a play of the gaming machine to end.

45. A gaming machine monitoring method for monitoring a plurality of gaming machines from a remote site, the method including: providing a plurality of local accumulators, each accumulator associated with a plurality of the gaming machines; summing metered data from the associated machines of the local accumulators; and passing the summed data from the local accumulators to a remote central control.

46. The method of claim 45, wherein the summed data is the metered turnover data of each of the associated machines of an accumulator added together.

47. The method of claim 45, wherein the accumulators store individual machine metered data, and wherein the central control requests individual data from the accumulators based on a processing of the summed data.

48. Gaming machine software for a local controller that monitors a plurality of local gaming machines, including a component for receiving metered data from the machines, a component for summing the received data, and a component for transmitting the received data to a remote monitoring station.

49. Gaming machine software for a central control for monitoring a plurality of remote gaming machines, the software including a component for receiving summed metered data from a remote controller associated locally with the gaming machines, a component for storing the summed data, and a component for determining a summed delta value comprising the difference between a current summed value for the metered readings of the machines of the remote controller and a previously transmitted value.

50. A gaming machine accumulator that monitors a plurality of local gaming machines, the accumulator receiving metered data from the machines, summing the received data, and transmitting the received data to a remote monitoring station.

51. A gaming machine central control for the monitoring of remote gaming machines, the central control including means for receiving summed metered data from a remote controller associated locally with the gaming machines, means for storing the summed data, and means for determining a difference between a current summed value for the metered readings of the machines and a previously transmitted value.

52. A linked jackpot system, in which a plurality of gaming machines at a plurality of venues are linked together by a remote central control to play for a common jackpot prize, wherein each venue includes an accumulator for receiving metered data from the participating machines at that venue and for summing said data and sending said data to said central control, said central control processing said summed data to control a jackpot.

53. The system of claim 52, wherein the summed data includes turnover data.

54. The system of claim 52, wherein the processing is the calculation of a delta value between a currently received summed data value and a previously received summed data value.

55. The system of claim 52, wherein the summed data is assigned identification data, the identification data being sent to said central control with said summed data.

56. The system of claim 55, wherein the central control associates a jackpot win with a particular summed data communication, and informs the relevant accumulator of the win, and wherein the accumulator determines which gaming machine is to win the jackpot

57. The system of claim 55, wherein the accumulator determines which gaming machine is to win the jackpot by determining the individual machine contributions to the summed data value that is associated with the win.

58. A system for the remote monitoring of a plurality of gaming machines having metered data, wherein the gaming machines communicate with a local accumulator that sums together metered data from the machines, and wherein the accumulator forwards this summed data to a remote central control.

59. A remote monitoring system in which a plurality of metered devices are monitored by a remote central control, wherein the metered devices are split into groups, and each group of devices has an accumulator associated therewith for receiving metered data from the individual devices of the group and for sending a sum of the metered data to a central control for processing.

60. The system of claim 59, wherein the system monitors people passing through the turnstiles of a venue or monitors cash registers.

61. A method of controlling or monitoring a plurality of metered devices using a remote central control, including: splitting the metered devices into groups; associating a local accumulator with each of the groups for receiving metered data from the individual devices of the groups; and sending a sum of the metered data to a central control for processing.

62. A gaming means system for remotely monitoring gaming means, the gaming means each including at least one metering means for providing metered data, wherein the system includes a plurality of local accumulating means, in communication with one or more of the gaming means, for: receiving metered data from the machines; summing-together metered data from its associated gaming means; and communicating the summed data to a remote central control means.
